(19) United States
(12) Patent Application Publication
(10) Pub. No.: US 2015/0140185 A1
(43) Pub. Date: May 21, 2015

(54) SOLVENT-FREE APPROACH FOR SEPARATION OF CONSTITUENT FRACTIONS OF PULSES, GRAINS, OILSEEDS, AND DRIED FRUITS

(71) Applicant: Advanced CERT Canada Inc., Waterloo (CA)

(72) Inventors: Amin Reza Rajabzadeh, Waterloo (CA); Mousa Jafari, Waterloo (CA); Raymond Louis Legge, Waterloo (CA)

(21) Appl. No.: 14/546,890

(22) Filed: Nov. 18, 2014

Related U.S. Application Data
(60) Provisional application No. 61/906,240, filed on Nov. 19, 2013.

(51) Int. Cl. A23L 1/025; A23L 1/212; A23L 1/10; A23L 1/211

(52) U.S. Cl. CPC A23L 1/025; A23L 1/2117; A23L 1/2121; A23L 1/1041; A23V 2002/00
USPC 426/239

(57) ABSTRACT

The present invention relates to a novel solvent-free process for the production of protein-, starch- and fiber-enriched fractions or fractions rich in specific compounds from pulses, grains, oilseeds, and dried fruits. Unlike conventional wet processes, this dry process preserves the natural configuration and structure of separated components. This process employs a tribo-electrostatic technique to selectively charge proteins, carbohydrates, fibers, and other components in pulses, grains, oilseeds, and dried fruits and separates them based on the magnitude and type of their charge. The invention also relates to the protein-, starch-, and fiber-enriched fractions or fractions rich in specific compounds obtained using the process of this invention, and to the use of these fractions in a variety of applications that include the food industries, in particular gluten-free market, in the production of high functional protein concentrates and isolates, in particular soy protein concentrate and isolate, as pharmaceutical and/or nutraceutical agents, and in the production of bio-based materials.

### FIELD OF THE INVENTION

The present invention relates to a novel solvent-free process for the production of protein, starch and fiber-enriched fractions or fractions rich in specific compounds from pulses, grains, oilseeds, and dried fruits.

### BACKGROUND OF THE INVENTION

Pulses, grains, oilseeds and fruits are major staple foods and sources of important nutrients. In recent years, increasing evidence has shown many added health benefits of consuming pulse, grain, oilseed and fruit containing foods. For instance, populations with high intakes of pulses have shown lowered risks of cardiovascular diseases, diabetes and obesity. In addition to their health benefits, the protein extracted from these resources is an environmentally conservative protein resource that has significant economic advantages over more expensive meat and dairy proteins. A good example is bean protein, which is considered as an excellent source of non-animal protein containing a significant proportion of the essential amino acids required for optimal human health. Yet another use of such proteins is in the production of protein-enriched flours. The fast growing gluten-free market requires innovative technologies to provide functional flours to replace gluten-containing products. This usually requires protein-enriched flours to enhance the nutritional value of the final product and replace the gluten, conferring functionality to the flour.

Processing of pulses, grains, oilseeds, and dried fruits, especially the fractionation of their major components (protein, starch and fiber), still relies on conventional technologies, which are usually based on wet processes, and involve the use of solvents, alkali and/or concentrated acids. For instance, soy protein isolates (SPI) are traditionally prepared from defatted soy flakes/flours through a series of unit operations that include aqueous extraction, centrifugation, isoelectric precipitation, washing, neutralization, and drying. Such processing conditions can result in protein denaturation and loss of solubility, reducing the quality and functionality of the protein ingredients. In the wet processes, large volumes of whey-like acid effluents with relatively high quantities of proteinaceous material are generated which can result in water quality issues.

Few dry separation technologies have been developed to classify powdery or granular materials, in particular flours. Air classification and sieving are examples of dry separation processes generally employed to fractionate powdery materials. Air classification is suited for classifying fine powdery matters usually smaller than 300 μm in size. This technology, however, requires large and costly equipment. Sieving, on the other hand, provides poor classification efficiency. A combination of both technologies has also been suggested by EP 1,372,409B1, for separating de-oiled sunflower meal into fiber- and protein-enriched fractions. The separation was carried out by milling, sieving, and subsequently wind sifting.

U.S. Pat. No. 5,336,517 describes the effect of size, moisture content, and softness of different types of wheat flours on the efficiency of air classification to obtain protein- and starch-enriched fractions. In this patent, Graveland et al. claim that the re-milling of the flour using a jet air mill, Retsch mill or an extruder enhances the efficiency of separation process by disrupting the endosperm of the particles and reducing the specific size diameter X-50 to less than 40 μm, preferably 15-25 μm. They also claim that increasing the moisture content to 17% before re-milling and decreasing that to 8% prior to air classification enhance the efficiency of milling and separation, respectively. Using their process, they increased the protein content from 11.2% in the original flour to 26.7% in the final product.

Reference may also be made to U.S. Pat. No. 3,965,086, by Swain, et al., wherein a partially dry method for producing protein concentrate by grinding, air classification and washing the oil seed meal is described. The process comprises different steps of fine grinding the oilseed meal, making a first air classification of the meal and re-milling the fine fractions to where 90% of the particles are less than 20 microns in diameter, performing a second air classification of the milled fraction and washing the coarse fraction in water at pH 4-6. Using this process, the inventors increased the protein content from 52.5% in the soy flour to 59.2% in air classified fraction and up to 76.3% after the washing step.

The other dry-based separation technology developed to separate powdery or granular materials is electrostatic separation. It is employed in various areas such as the production of minerals, the recovery of valuable materials, and cleaning food products like sesame or poppy seeds by removing hulls.

Different types of electrostatic separator apparatus are known in the art. There are only three mechanisms available for imparting the electrostatic charge onto particles, including corona charging, induction charging, and tribo-charging. Corona charging is based on the ion bombardment of particles through ionized gas stream and can effectively separate conductive and non-conductive particles. The principle of induction charging is also based on conductivity and polarity of the particles. As there is no significant difference in the conductivity of protein- and carbohydrate-rich particles, these two methods are not applicable in this invention.

U.S. Pat. No. 8,029,843 describes a method for the extraction of aleurone components from wheat bran, using a combination of wet enzymatic reactions and dry mechanical separation. As a part of their process, the inventors suggested using electrostatic field to separate aleurone-containing particles (rich in vitamins, minerals and anti-oxidant compounds) from non-aleurone hull particles. The particles in their system were charged during their passage through an air classifier channels.

### SUMMARY OF THE INVENTION

The focus of this invention is on electrostatic separation of constituent fractions of pulses, grains, oilseeds, and dried fruits applying tribo-charging of particles which is believed to be the most suitable technique to charge the proteins and carbohydrates to substantially different levels. Up to now, this technology has not been employed for separating pulse, grain, oilseed flours and dried fruits into protein and starch, and fiber-enriched fractions.

Tribo-charging is based on imparting charge on the surface of particles through physical contact or friction against other dissimilar particles. The surface frictional charge is accumulated through rubbing the particles together in transit conveying or through coming into physical contact with each other or other materials such as walls of containers or pipes while in motion. The contact or friction can be created through a fluidized bed, a vibrating bed, or a pneumatically conveyed stream of particles.

The build-up and transfer of charge depends on the dielectric constant or work function of the particles. Work function is the required minimum energy to remove electrons from the surface of the particle. Upon physical contact between two materials with different work functions, some electrons achieve high energy states. To equalize the energy of the electrons, some electrons are transferred from the surface with a lower work function to the surface with higher work function. As a result, the material with a lower affinity for electrons charges positively; while, the particle with a higher affinity for the electrons charges negatively.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows process flow diagram of the novel electrostatic separation process including feeding, tribocharging and separation units;

FIG. 2 shows SDS gel electrophoresis of navy bean flour, separated fractions, navy bean isolate and 7s globulin;

FIG. 3 shows CD spectroscopy of proteins extracted from navy bean flour, separated protein-rich fraction, and acid-precipitated navy bean isolate in water (ph=7);

FIG. 4 shows Fluorescence spectroscopy of Navy bean protein at different pH's; and

FIG. 5 shows Fluorescence spectroscopy of proteins extracted from navy bean flour, dry separated protein-rich and starch-rich fraction fractions, and acid-precipitated navy bean isolate in water (pH=7).

### DETAILED DESCRIPTION OF THE DRAWINGS

It is the main objective of the present invention to provide a new and innovative solvent-free process using tribo-electrification to separate protein-rich particles from starch-rich and fiber-rich fractions in the pulses, grains, oilseeds, and dried fruits.

Ionizable or polar groups are required in order to effectively tribocharge a particle by ion or electron transfer. In the proteins, the N-terminus amino group, the C-terminus carboxyl group, and any ionizable groups on the side chains are the available target sites. Carbohydrates, in contrast, do not possess ionizable groups and prefer not to donate/accept electrons or hydrogen ions; thus, carbohydrate-rich particles including starch are characterized by low ionizability and proton affinity.

Different contact materials including polymers such as PolyTetraFluoroEthylene (PTFE), Polyvinyl Chloride (PVC), Nylon and metals, such as copper, were tested to evaluate their efficiency to tribocharge proteins and carbohydrates. The protein powder (soy concentrate in this example) was dried at 70° C. for 4 h. One gram of sample was added to the tubes (20 cm length×1 cm inner diameter), made from different contact materials. Using a vibrator and allowing a 2 min contact time, the charge of the powder was measured using a Faraday cup. As listed in Table 1, PTFE showed the highest triboelectrification efficiency followed by PVC and Nylon. Copper was not able to charge the protein powder as the charge to mass ratio of the sample treated with copper was almost as the same as non-treated powder sample.

TABLE 1
Effect of contact material on Soy protein tribocharging

| Contact material | Absolute charge/mass (nC/g) |
|---|---|
| Non-charged | 6 ± 2 |
| Copper | 5 ± 1 |
| Nylon | 228 ± 53 |
| PVC | 270 ± 32 |
| PTFE | 556 ± 29 |

As electron acceptors, most materials including metals and polymers, in particular PTFE, tend to pull unbounded electrons from the particles due to their work function. As the proteins in this study have more negatively charged carboxyl and functional groups than the positively charged amino groups (with isoelectric points below 6), they exhibit a net negative chemical charge. Therefore, the unbounded electrons on the carboxyl or other functional groups on the protein are easily transferred to PTFE. This process increases the triboelectrification efficiency which is quantified by increased charge-to-mass ratio. It should be noted that triboelectrification of carbohydrates (corn starch in this example) with PTFE at the same experimental condition leads to a charge-to-mass ratio of 89±17, almost one sixth of that of protein (556±29). This variation in tribocharging characteristics of the proteins and carbohydrates provides enough driving force for the separation process.

The process of tribocharging and separation of pulse, grains, defatted oilseed flours, and dried fruits comprises:
1. pre-milling treatment including toasting, tempering, or conditioning;
2. a milling step or multiple milling steps;
3. a fractionating step for separating according to particle size, preferably via sieving;
4. re-milling of the desirable fraction to further reduce the particle size;
5. a drying/heating step;
6. tribocharging of the flour through friction of particles with contact material and with each other; and
7. separation of protein-, starch- and fiber-enriched fractions by making the particles fall through an electric field.

The process does not necessarily follow the exact sequence as listed above. For instance, based on the type of the flour, a toasting or tempering step might be necessary on the final product or after the re-milling step.

Any plant-based protein-containing resources, including pulses, grains, oilseeds and dries fruits can be used in this invention to be separated into protein-, starch-, and fiber-rich fractions. Pulses are selected from the group consisting of beans, peas, lentils, and mixtures thereof. Grains are selected from the group consisting of corn, wheat, barley, oats, quinoa, millet, sorghum, couscous and rice, and mixtures thereof. In particular, this novel separation technology can be used to produce low-gluten and high-gluten wheat flours. Oilseeds are also selected from the group consisting of soybean, rapeseed, flaxseed, sunflower, sesame, mustard, canola, safflower seed and mixtures thereof. Preferably the oilseeds are de-oiled prior to the separation process. Dried fruits include but are not limited to berries, nuts, peaches, figs, avocado and mixture thereof.

The particles sizes are reduced through milling. Preferably, the mill is selected from the group consisting of stone mill, pin mill, ball mill, and jet mill. The milling should preferably result in D-90 of 150 μm (90% of the particles with less than 150 μm in diameter).

Furthermore, mechanical fractionating on the flours is carried out preferably via sieving. The particle size fraction of below 125 μm is collected for the separation step. The fraction with particle size above 125 μm is collected as the fiber-rich fraction.

Based on the original milling and particle size distribution of the fraction (below 150 μm), a re-milling step is carried out to further reduce the particle size and to enhance the disaggregation of starch-protein particles.

A drying step is preferably carried out to reduce the moisture content of the fraction below 16% (water by weight on wet basis), preferably 11% and more preferably 6%. The drying apparatuses include but are not limited to air drying ovens, microwave dryers, vacuum ovens and fluidized beds. The temperature range for drying step could be between 0° C. to 100° C., preferably between 20° C. and 80° C.

Tribo-charging of particles is preferably carried out using a gas stream. The dried flour fraction is suspended in a gas stream (preferably air or nitrogen stream) and the particles are tribo-charged via friction with each other and with the walls of the channel(s) (preferably a multi-channel tubular path) which serves for pneumatically conveying the mixture to the separator. The tubes are made of or are coated with special contact materials which tribo-charge proteins and starch differently. Preferably, this contact material is PTFE, PVC, or Nylon.

The tribo-electric section alternatively includes a fluidized bed with internal baffles to suspend particles in a gas flow (preferably air or nitrogen stream) in the bed and to provide surface and contact time for the particles to physically contact each other and the inner surface of the fluidized bed. The walls and baffles of fluidized bed are made of or coated with special contact materials which tribo-charge proteins and starch differently. Preferably, this contact material is PTFE, PVC, or Nylon.

In another embodiment of the present invention, a tribo-gun can be used to charge the particles. The particles in a gas stream (preferably air or nitrogen stream) are made to pass through the channels of the tribo-gun. The inner surface of tribo-gun channels are made of or are coated with special contact materials which tribo-charge proteins and starch differently. Preferably, this contact material is PTFE, PVC, or Nylon.

Preferably, the gas stream is dried and heated to a temperature range between 0° C. and 80° C.

Once the protein, carbohydrate, and other ingredients in the flour are charged relative to their surface chemistry, they are made to fall through an electric field which deflects the particles according to the size, shape, and mass of the particles, and the magnitude and type of their charge.

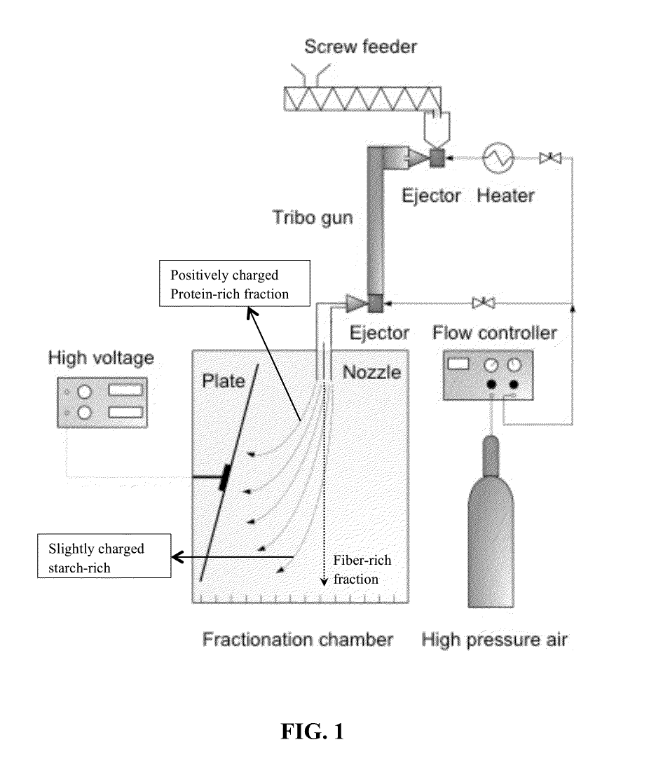

The separating apparatus is preferably a chamber in which at least one electrode, preferably two electrodes, in the form of plates diverging progressively from top to bottom are arranged. These plates are made of conductive materials, preferably copper, and are preferably oppositely charged. The charge to the electrodes with a voltage of ±0.1 kV to ±40 kV is provided by a high DC voltage supply. The tribocharging and separating sections can be connected directly or via a cyclone coated with the contact material. FIG. 1 shows a schematic view of the feeding, tribo-charging and separating units.

Alternatively, the separating apparatus has cylindrical or conical structure with two annular electrodes, one in the axial centerline of the chamber and another adjacent the chamber wall.

The separated particles can be collected in the collecting bins (at least three bins) at the bottom of the chamber. Alternatively, the bottom of the chamber can be connected to the cyclones to separate gas flow from the separated particles.

The separation efficiency can be enhanced by recycling the separated fractions to the inlet of the separator for further enrichment. Alternatively, the outlets of the first separator are connected to the second separators to further enrich the protein and starch or other content in their corresponding fractions.

As the proteins are positively charged after tribocharging with contact materials, preferably PTFE, PVC, or Nylon, the particles collected in the bins (or cyclones) located near the negatively charged plate(s) are protein-enriched particles.

Protein-enriched fraction(s) separated or isolated by this method can be used in gluten-free food products, as an additive in foodstuffs or feedstock, as a food supplement or feed supplement, as a protein concentrate and/or isolate, and as nutraceutical and/or pharmaceutical products.

As the starch particles are only slightly charged, the fractions away from the negatively charged plate(s) are starch-rich fractions.

Starch-enriched fraction(s) separated or isolated by this method can be used in food products, in particular gluten-free products, cosmetic, biofuel industries, and pharmaceutical industries. Starch improves the texture, stability and appearance of food products. The detergent industry uses starch products for the production of biodegradable, non-toxic and skin friendly detergents. Starch is also used quite extensively in cosmetic, make up and healthcare products.

The fractions collected in the bins below the feeding point (usually middle of the chamber) can also include fiber-rich particles. Due to their higher density compared to those of protein- and starch-rich particles, fiber-rich particles are not deflected in the voltages which easily deflect protein and to some extent starch particles. It should be noted that the bulk of fiber is collected during the sieving process.

Fiber-enriched fraction(s) separated or isolated by both methods can be used as nutraceutical and/or pharmaceutical products, as an additive to food products or for feeding ruminants. The soluble and insoluble fiber in beans lowers the blood cholesterol level, helps with digestion, and maintains regular bowel movements.

The protein, starch, and fiber-enriched fractions can be also used in the development of biomaterials, in particular bio-composites. For instance, the separated soy protein fraction can be applied in the development of soy protein plastic based composites.

Other source of products may include specific enzymes and proteins extracted from separated protein-rich starch-rich and/or fiber-rich fractions. For instance, the production of peroxidase from the fiber-rich fraction of bean flour is of environmental and economic interest. Peroxidase can be used in wastewater treatment, soil remediation, bread dough conditioning, as a bleaching agent in the pulp and paper industry and as a substitute for horseradish peroxidase in medical diagnostics.

### EXAMPLE 1

Separation of protein-rich and starch-rich particles: food-grade de-oiled soy isolate and corn starch powders were mixed in a 50/50 weight ratio. The powder mixture then underwent a drying step in an air drying oven at 70° C. for 4 hours. The mixture was then suspended in a dry air stream (60° C.) using a fluidized bed and was forced to pass through the custom-built tribo-gun channels, coated with PTFE. The charged particles were then separated in a separating apparatus based on the magnitude and type of surface charge. The separating apparatus was a chamber in which an electrode in the form of a copper plate diverging progressively from top to bottom was arranged. The electrode was negatively charged with a voltage of −1 kV by a high DC voltage supply. Samples on the plate or the beneath of the plate which were significantly deflected by high voltage field were collected as the protein-rich fraction and those at the bottom of the chamber which were not (or slightly) deflected by the field were collected as starch-rich fraction. Approximately 40 mg of each sample was dried at 100° C. for 3 hours, before conducting Kjeldahl analysis for protein content measurement. The recovery percentage in the table represents the total weight of each fraction over the weight of the feed.

The results of separation are as follows:

TABLE 2
Result of separation for example No. 1

| | | | % corn | |
|---|---|---|---|---|
| | % protein | % soy iso- | starch | |
| | by weight | late by | by weight | Recov- |
| Original powders or | on dry | weight in | in the | ery |
| separated fractions | basis | the sample | sample | (w/w %) |
| Soy isolate | 90 | 100 | — | — |
| Corn starch | 0 | — | 100 | — |
| Feed (50/50 mixture) | 45 | 50 | 50 | — |
| Protein-rich fraction | 86 | 95 | 5 | 42 |
| Starch-rich fraction | 15 | 17 | 83 | 58 |

### EXAMPLE 2

Pin-milled Navy bean flour (Hosokawa Alpine pin mill) was screened by sieving (125 μM) so as to obtain a fraction with particle sizes below 125 μm. The sized fraction then underwent the same drying, charging and separation steps as described in Example 1. The configuration of the setup and operating conditions were as the same as described in Example 1.

The results of separation are as follows:

TABLE 3
Result of separation for example No. 2

| | % protein by weight | Recovery |
|---|---|---|
| Feed or fractions | on dry basis | (w/w %) |
| Navy bean flour | 24 | — |
| Navy bean fraction (<125 μM) | 26 | — |
| Protein-rich fraction | 52 | 38 |
| Starch- and fiber-rich fraction | 13 | 62 |

### EXAMPLE 3

Disk-milled Quinoa flour underwent the same drying, charging and separation steps as described in Example 2. In this example, the voltage of electrode was set to −2 kV.

The results of the separation are as follows:

TABLE 4
Result of separation for example No. 3

| | % protein by weight | Recovery |
|---|---|---|
| Feed or fractions | on dry basis | (w/w %) |
| Quinoa flour | 14 | — |
| Protein-rich fraction | 22 | 47 |
| Starch- and fiber-rich | 7 | 53 |
| fraction | | |

### EXAMPLE 4

The protein profile of pin-milled navy bean flour and separated fractions from Table 1 was compared with those of navy bean isolate and 7S globulin, using Sodium dodecyl sulfate polyacrylamide gel electrophoresis (SDS-PAGE). To extract proteins from powder samples, navy bean flour or collected samples (5 w/v) were suspended in 0.02% NaOH solution and were shaken in water bath (50° C.) for 2 h. The samples were then centrifuged at 14000×g for 15 min and supernatants were collected for analysis.

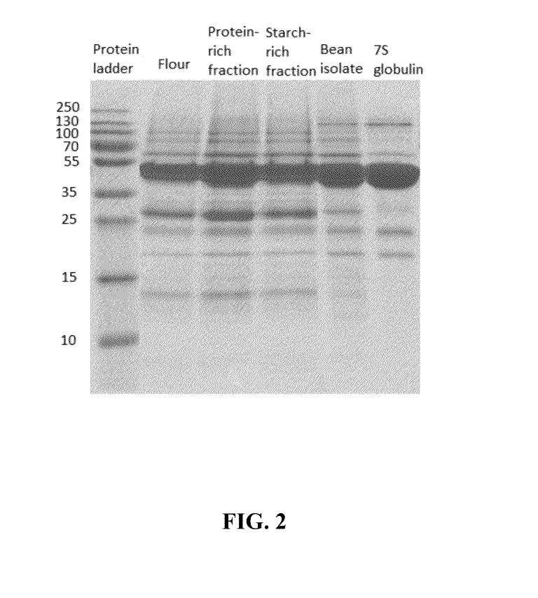

As shown in FIG. 2, the protein profile of fractions separated by the dry process is very similar to that of bean flour, implying that the novel process preserves the protein distribution of the flour. However, the protein profiles of navy bean isolate, prepared by acid precipitation at its isoelectric point, and isolate 7S globulin, extracted under acidic condition pH=2, are devoid of certain bands, especially for proteins with MWs of less than 15 kDa. These bands mostly represent the water-soluble albumin fraction which are lost during acid precipitation due to their relative solubility at the isoelectric point. There are also some high MW polypeptide aggregates (130 kDa) in isolate samples which do not exist in the flour or separated fractions, implying that protein structural change occur during solvent extraction due to the nature of the processing conditions.

### EXAMPLE 5

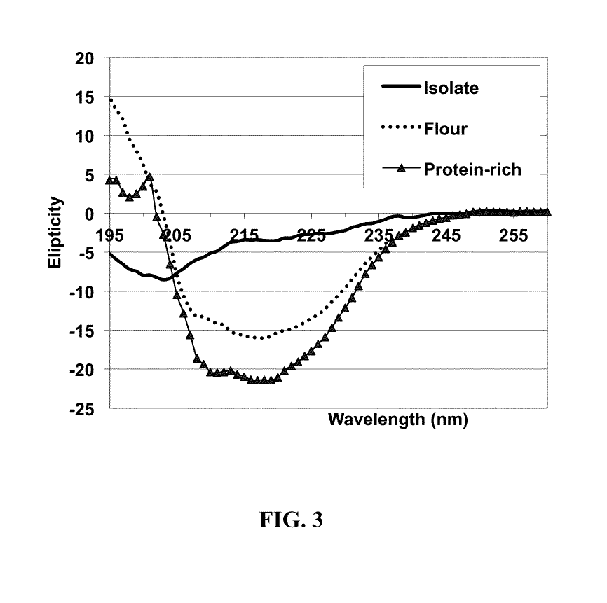

Circular dichroism spectroscopy: The conformation and secondary structure of pin-milled Navy bean flour and dry separated fractions from Example 2, and acid precipitated navy bean isolate was studied by CD spectroscopy. This technique has been widely used to evaluate protein stability and conformational change under different processing conditions (Jafari et al., Biochemistry 2013, vol 52, 3428-3435). Protein solutions, extracted in Milli-Q water (pH=7) based on the procedure described in Example 4, were transferred into 1 mm long quartz cells. Spectra from 250 to 190 nm were recorded with a J-810 spectropolarimeter (Jasco, USA) at 25° C. As shown in FIG. 3, bean protein isolate shows a minimum around 203 nm which represents random coil secondary structure. However, proteins of flour and protein-rich fraction exhibited a helical structure with two minima at 208 and 220 nm. The CD results confirm that the wet processes produces a protein isolate with significant changes to the structure of the proteins especially at pH's around their isoelectric point. On the other hand, the dry process preserves the natural structure of proteins during separation.

### EXAMPLE 6

Fluorescence spectroscopy: The conformational change in pin milled navy bean protein at different pH's was studied by fluorescence spectroscopy. Protein fluorescence is related to intrinsic fluorophores mainly due to tryptophan and tyrosine amino acids. The change in fluorescence emission spectra can reflect the conformational change of a protein due to aggregation, dissociation, or denaturation (Elshereef et al., Biotech. & Bioeng., 2006, Vol. 95, 863-874).

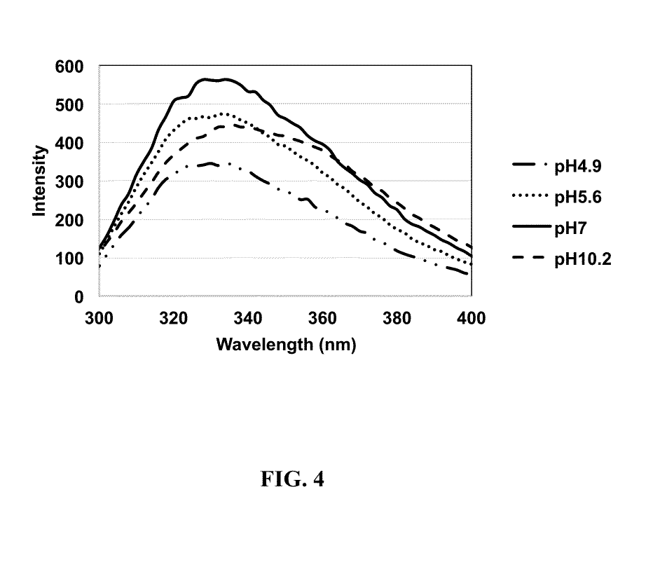

Fluorescence measurements were conducted in a 1.0-cm cuvette using a Varian Cary Eclipse Fluorescence Spectro-photometer (Palo Alto, Calif.). Fresh protein solutions (3 ml), extracted at different pH's as described in Example 4, were transferred to a quartz cell (1 cm×1 cm) and excited at the wavelength of 290 nm. The emission spectra were recorded in the region 300-400 nm with a slit width of 5 nm. As shown in FIG. 4, by changing the pH from 10.2 to 4.9, a 10 nm blue shift from 340 nm to 330 nm in emission peak was observed. This also confirms that reducing the pH to isoelectric point, which is a common approach in protein isolate production, causes significant change in protein structure. As the invented dry process does not change the microenvironment of proteins, it is a safe alternative for production of protein-rich fractions.

### EXAMPLE 7

Fluorescence Spectroscopy: The effect of acid precipitation on the conformational change of navy bean protein was also studied by fluorescence spectroscopy. Proteins of pin milled navy bean flour, separated protein-rich and starch-rich fractions, and acid-precipitated navy bean isolate were extracted in Milli-Q water at pH=7 based on the procedure described in Example 4. Fluorescence measurements were conducted following the same procedure as described in Example 6.

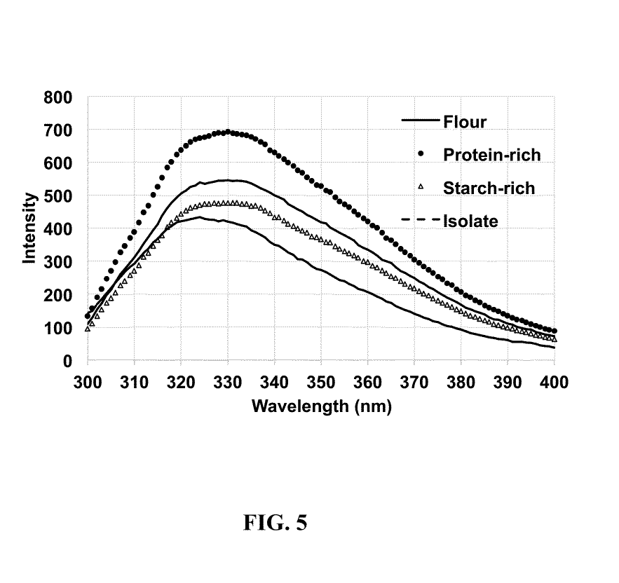

As shown in FIG. 5, protein solutions of flour and dry separated protein-rich and starch-rich fractions show fluorescence spectra with a peak around 330 nm. However, the fluorescence spectrum of navy bean isolate shows a peak at 324 nm. As all samples were prepared at the same experimental conditions, different maximum peak in isolate spectrum may reflect different micro-environment of aromatic amino acids in isolate sample in comparison to the flour and dry separated fractions. The lower intensity of isolate sample may also indicate its low solubility at pH=7.

What is claimed is:

1. A solvent-free process for separating proteins, starches, and fibers from natural particles, said natural particles selected from the groups consisting of pulses, grains, oilseeds and dried fruits, said process producing a protein-enriched powder, a starch-enriched powder, and a fiber-enriched powder, said process comprising steps of:
a. milling the natural particles to produce a natural powder and to reduce the size of the particles, said natural powder having loosen bonds between the molecule of proteins, starches, and fibers;
b. fractionating the natural powder according to the particle size;
c. re-milling a desirable fraction to further reduce the particle size and to enhance the disaggregation of starch-protein particles;
d. drying/heating the natural powder to reduce the moisture content of the fraction;
e. tribo-charging the natural powder by using a contact material or in a gas stream, or by contact the natural powder on itself; and
f. separating the natural powder into a protein-enriched powder fraction, a starch-enriched powder fraction, and a fiber-enriched powder fraction, by allowing the natural powder to fall through an electric field into a plurality of bins.

2. The solvent-free process of claim 1, wherein the contact material being selected from the groups consisting of PTFE, PVC, Nylon, and Copper.

3. The solvent-free process of claim 1, wherein tribo-charging of particles being carried out using a gas stream, wherein said particle being tribo-charged via friction with each other and with the walls of a path preferably a multi-channel tubular path.

4. The solvent-free process of claim 1, wherein the tribo-electric section further having a fluidized bed with internal baffles to suspend the particles in a gas flow in the bed and provide time and surface for particles to physically contact with each other and with inner surface of the fluidized bed.

5. The solvent-free process of claim 1, wherein the particles in a gas stream being forced to pass through the tribo-gun channels.

6. The solvent-free process of claim 1, wherein the tubular path, the fluidized bed and its baffles, and the tribo gun being made of or coated with said contact materials which tribo-charge the protein and starch differently.

7. The solvent-free process of claim 1, wherein the separating apparatus being a chamber in which at least one electrode in the form of plate being arranged to diverge progressively from a top to a bottom.

8. The solvent-free process of claim 1, wherein the separating apparatus has cylindrical or conical structure with two annular electrodes, one in the axial centerline of the chamber and another with opposite charge adjacent the wall of the chamber.

9. The solvent-free process of claim 1, wherein the electrodes being made of conductive materials, preferably copper, and being preferably oppositely charged.

10. The solvent-free process of claim 1, wherein the charge to the electrodes with a voltage of ±0.1 kV to ±40 kV being provided by a high DC voltage supply.

11. The solvent-free process of claim 1, wherein the tribo-charging and separating sections being connected directly or via a cyclone coated with the contact materials.

12. The solvent-free process of claim 1, wherein the bottom of the chamber being connected to the cyclones to separate gas flow from the separated particles.

13. The solvent-free process of claim 1, wherein the milling process produces a powder in which 90% of the powder sizes being less than 150 μm in diameter to loosen the bonds between proteins, starches, and fibers.

14. The solvent-free process of claim 1, wherein the drying/heating process at a temperature between 0° C. to 100° C. results in less than 6-16% water by weight on wet basis.

15. The solvent-free process of claim 1, wherein the particles collected in the bins close to the negatively charged plates being said protein-enriched powder and the fractions in middle of the chamber or away from the negatively charged plates being said starch-rich powder, wherein the fractions collected in the bins below the feeding point at a middle of the chamber comprises of said fiber-rich powder.

16. The solvent-free process of claim 1, wherein the particles collected in any of the bins being rich in a particular biochemical compound including proteins, enzymes, and anti-oxidants.

17. The solvent-free process of claim 1, wherein pulses are selected from the groups consisting of beans, peas, lentils, and mixtures thereof.

18. The solvent-free process of claim 1, wherein grains are selected from the groups consisting of corn, wheat, barley, oats, quinoa, millet, sorghum, couscous and rice, and mixtures thereof.

19. The solvent-free process of claim 1, wherein oilseeds are selected from the groups consisting of soybean, rapeseed, flaxseed, sunflower, sesame, mustard, canola, safflower seed and mixtures thereof.

20. The solvent-free process of claim 1, wherein the natural chemical structure and configuration of separated proteins, starches, fibers, and other biochemical compounds are preserved.
